(19) United States
(12) Patent Application Publication
(10) Pub. No.: US 2017/0131690 A1
(43) Pub. Date: May 11, 2017

(54) MECHANICAL DEVICE MOVEMENT DETECTION

(71) Applicant: International Business Machines Corporation, Armonk, NY (US)

(72) Inventors: Alessandra Asaro, Rome (IT); Marco Gianfico, Sant'Antimo (IT); Roberto Ragusa, Rome (IT); Marco Vettori, Anzio (IT)

(21) Appl. No.: 14/936,730

(22) Filed: Nov. 10, 2015

(51) Int. Cl. G05B 15/02; G01L 5/00; G10L 15/22

(52) U.S. Cl. CPC G05B 15/02; G10L 15/22; G01L 5/00; G10L 2015/223

(57) ABSTRACT

A method, computer program product and computer system is provided. A processor retrieves a plurality of pressure readings from a matrix of pressure sensors. A processor identifies a movement within the matrix of pressure sensors based, at least in part, on the plurality of pressure readings. In response to a determination that the movement is characteristic of a movement assisting device, a processor enables a voice recognition system for receiving speech commands to operate a device.

### BACKGROUND OF THE INVENTION

The present invention relates generally to the field of movement detection, and more particularly to detecting a moving device on a floor.

Individuals with limited mobility, for example, individuals using, crutches, or people using a stroller for a baby, may, in some environments, have difficulties operating equipment like control systems of elevators or other access doors, such as floor buttons or opening entrance doors of a building. Such operating panels may be difficult to reach for those individuals because the operating panels are mounted in a position that is difficult for them to access safely or other obstacles, such as a baby stroller, luggage, etc. are in the way. In other situations, parents using a stroller may carry the baby and not be able to use the operating keyboard. Additionally, people using a walking frame or crutches may have difficulties using a free hand to safely operate an elevator or a door opening actuator.

### SUMMARY

Embodiments of the present invention provide a method, system, and program product to enable voice operation of a device in response to a movement assisting device entering an area. A processor retrieves a plurality of pressure readings from a matrix of pressure sensors. A processor identifies a movement within the matrix of pressure sensors based, at least in part, on the plurality of pressure readings. In response to a determination that the movement is characteristic of a moving device, a processor enables a voice recognition system for receiving speech commands to operate a device.

### BRIEF DESCRIPTION OF THE SEVERAL VIEWS OF THE DRAWINGS

FIG. 1 is a functional block diagram illustrating a smart floor environment, in accordance with an embodiment of the present invention.

FIG. 2 depicts an example diagram illustrating a matrix of pressure sensors.

FIGS. 3A & 3B illustrate operational processes of a detection program of a smart floor system, on a computing device within the environment of FIG. 1, in accordance with an embodiment of the present invention.

FIG. 4 depicts a block diagram of components of the computing device executing a detection program, in accordance with an embodiment of the present invention.

### DETAILED DESCRIPTION

While solutions to detecting movement assisting devices, such as wheelchairs, crutches, walking frames, baby strollers, luggage etc., are known, they typically like accuracy generating many false positives and false negatives when detecting a moving such devices within an area. Previous solutions usually look at snapshots or point-in-time readouts of sensor data to determine if a movement assisting device is present in an area. Embodiments of the present invention recognize that by comparing sensor data collected over time, a more accurate detection of movement assisting devices within an area is provided. In various scenarios, movement assisting device represents any device which detection may be instrumental for enabling people having difficulties reaching operating panels (e.g., elevators, doors, or other equipment). The movement assisting device may have wheels, such as a wheelchair, a wheeled stretcher, a stroller, a walking frame, or may be otherwise configures to assist in movement of a load, such as a moving dolly, a cart, a luggage rack, luggage itself (wheeled or otherwise), etc. In some scenarios and embodiments, a movement assisting device includes a person using that device to facilitate their own movement. In other scenarios and embodiments, a movement assisting device includes a person using that device to facilitate movement of an object other than themselves. For example, a large crate is on a moving dolly, which is being pushed by the individual.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

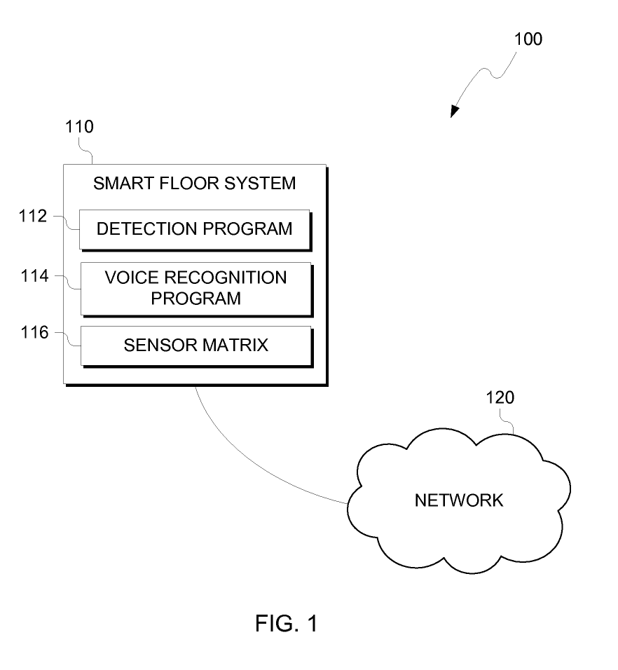

The present invention will now be described in detail with reference to the Figures. FIG. 1 is a functional block diagram illustrating smart floor environment, generally designated 100, in accordance with one embodiment of the present invention. Smart floor environment 100 includes smart floor system 110 connected to network 120. Smart floor system 110 includes detection program 112, voice recognition program 114, and sensor matrix 116.

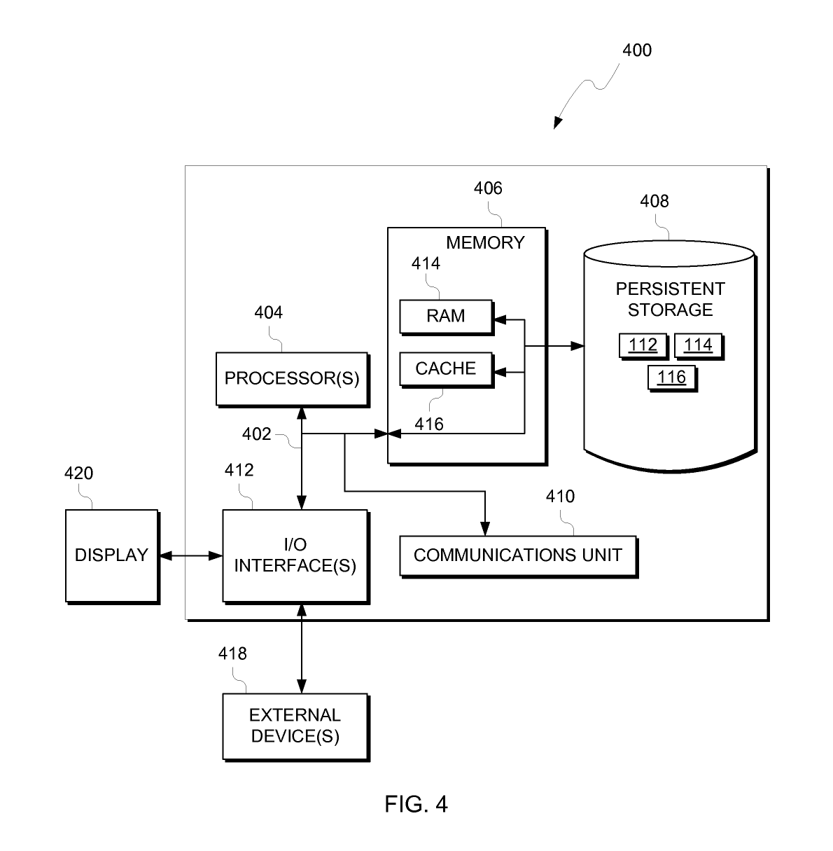

In various embodiments of the present invention, smart floor system 110 is a computing device that can be a standalone device, a server, a laptop computer, a tablet computer, a netbook computer, a personal computer (PC), or a desktop computer. In another embodiment, smart floor system 110 represents a computing system utilizing clustered computers and components to act as a single pool of seamless resources. In general, smart floor system 110 can be any computing device or a combination of devices with access to sensor matrix 116 and is capable of executing detection program 112 and voice recognition program 114. Smart floor system 110 may include internal and external hardware components, as depicted and described in further detail with respect to FIG. 4.

In this exemplary embodiment, detection program 112 and voice recognition program 114 are stored on smart floor system 110. However, in other embodiments, detection program 112 and voice recognition program 114 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between smart floor system 110 and one or more other devices (not shown), in accordance with a desired embodiment of the present invention.

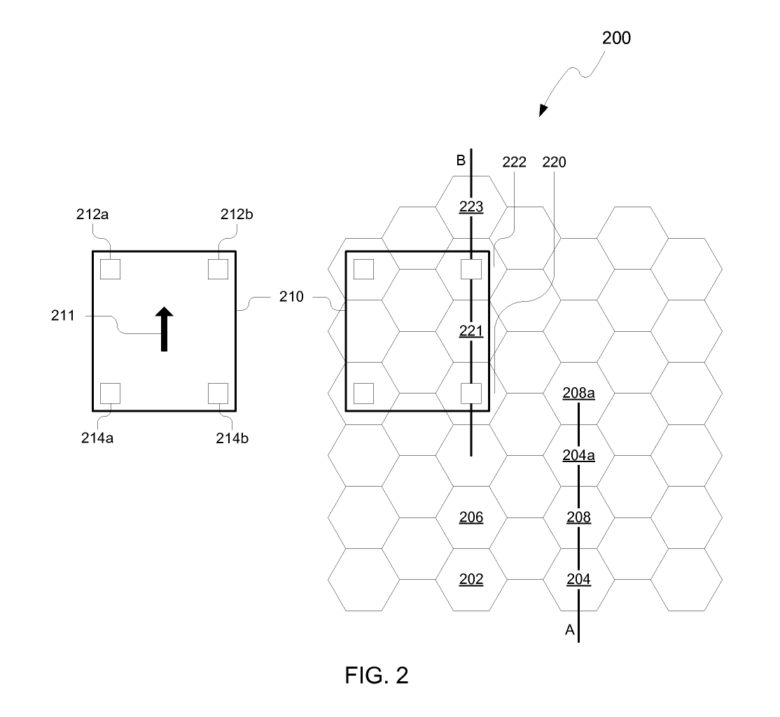

In various embodiments, smart floor system 110 includes sensor matrix to detect characteristic movement of movement assisting device and aides in an area. FIG. 2 illustrates a diagram of an example arrangement, designated 200, of a sensor matrix 116. In this example, arrangement 200 is shown with regular, symmetrical hexagons. As discussed herein, rectangular or rhomb-shaped pressure sensors or those with more corners may be used. Arrangement 200 also illustrates moving device 210. In this example, moving device 210, a type of movement assisting device, has four points of contact (e.g., four wheels) and may represent a wheelchair, pushcart, or gurney. Moving device 210 has two front wheels 212a-b and two rear wheels 214a-b. In this example, moving device 210 is illustrated as arriving from the bottom end of the arrangement 200. The two front wheels 212a-b of the moving device 210 may roll onto the pressure sensors 202 to 204 in a line A. If the moving device 210 continues to move forward the pressure sensors 206 and 208 may be activated. At the same time, the pressure sensors 202 and 204 may be released. Later as moving device 210 moves forward, the rear wheels 214a-b of the moving device 210 may be atop the pressure sensors 202, 204.

Arrangement 200 illustrates another characteristic movement, shown in the top left corner of the matrix of pressure sensors. Moving device 210 activates the pressure sensors 220 and 222. These two pressure sensors 220 and 222 are on a straight line B in the moving direction 211 of the moving device 210. If the moving device 210 continues to move forward, the pressure sensors 221 and 223 may be activated while at the same time and in the same direction 211 the pressure sensors 220 and 222 may be released. As a precaution it may be determined that the second set of pressure sensors 221, 223 may be activated for a predefined amount of time, in particular about two seconds. This time span may be adjusted according to the size of the pressure sensors. While arrangement 200 illustrates moving device 210 with four point of contact with arrangement 200, one skilled in the art will appreciate that that instead moving device 210 may be of the any other wheeled movement assisting device, like a stroller or a moving dolly, or a movement assisting device without wheels, such as a walking frame, crutches, or a magnetically levitated cart.

In some embodiments, sensor matrix 116 is a flat device, like a mat, in which pressure sensors have been embedded. The mat would be placed in an area where users would interact with an operable device (e.g., near a control panel in an elevator car). In other embodiments, sensor matrix 116 is place below a flooring material, such as a laminate, and is capable of determining pressure applied to the flooring material's surface (e.g., a movement assisting device placed on top of the floor).

The device generates a signal according to the pressure sensor or the pressure sensors may only detect that pressure is deployed to the mat under which the respective pressure sensor is embedded. Such a sensor may have a binary output. The pressure sensor of the first kind may generate an analogous signal or a digital signal relating to the pressure amount. The matrix may have segments in the form of regular, symmetrical hexagons, squares, octagons or other regular geometric shapes. A hexagon may have the advantage that using adjacent same-sized hexagons, a plane may be filled completely (compare FIG. 2).

In various embodiments, detection program 112 receives data from sensor matrix 116. Based on pressure, timing, and spacing of readings from sensor matrix 116, detection program 112 determines if a detected movement is characteristic for a movement assisting device. In one scenario, pressure readings are indicative of movement assisting device being used within as area covered by sensor matrix 116. For example, some movement assisting device have a smaller surface contact area with a floor than surface contact of a footprint of a person moving without a movement assisting device. In addition, the shape and pressure distribution of a footprint is not the same as that of, for example, a wheel. For example, the wheels of a wheelchair contact a smaller surface area than the typical foot size of an adult and the pressure over that area of contact is more consistent. Additionally, the overall weight distributed is not the same in both cases since the movement assisting device itself has weight. As such, a person with a movement assisting device will exert more pressure onto the sensors than that person without the movement assisting device.

In another scenario, detection program 112 determines characteristic movement of a movement assisting device based on the timing of activation for sensors in sensor matrix 116. Most movement assisting device, such as wheelchairs, carts, gurneys, strollers, and the like have wheels for movement. When moved, these types of movement assisting device have a more consistent level of contact with the floor, and by extension one or more sensors in sensor matrix 116. Conversely, for example, an individual that is walking without a movement assisting device will have a gait causing contact with sensor matrix 116 to be interrupted. As such, detection program 116 identifies consistent lines of movement to be an identifying characteristic of the use of a movement assisting device.

In another scenario, detection program 112 determines characteristic movement of a movement assisting device based the spacing of activated groupings of sensors in sensor matrix 116. Some movement assisting device are wider than an occupant or user of the device. For example, wheelchairs, walkers, strollers, and the like are typically different in size (either wider or narrower) than, for example, the standing width between the right and left footprints of a user. As such, the spacing between two activated groups in sensor matrix will be different when a movement assisting device is present on sensor matrix 116. Furthermore, movement assisting device have known spacing between points of contact, such as wheels in a wheelchair. As such, detection program 112 is configured to determine a characteristic movement when two groups of sensors are activated with a known spacing between the groupings. For example, wheelchairs are typically 26 inches wide wheel to wheel. A typical width between a right and left foot of an individual, while standing, is about seven inches. Based on known spacing, detection program 112 can determine when detected movement is characteristic of a movement assisting device.

One of ordinary skill in the art will appreciate that various embodiments of detection program 112 can be configured to determine characteristic movement of a movement assisting device based on one or more of (i) the received pressure of the sensor data; (ii) timing of activation for sensors in sensor matrix 116; (iii) and spacing between activation for sensors in sensor matrix 116, without deviating from the invention. By considering more than one indicator of characteristic movement and use of a movement assisting device, in addition to sensor matrix, a more accurate determination can be made as to the presence of a movement assisting device, thereby reducing the number of false determinations made by detection program 112.

When a characteristic movement of a movement assisting device is detected, detection program 112 sends an instruction to voice recognition program 114 to prompt a user for instructions to operate a device associated with smart floor system 110. For example, sensor matrix 116 is placed in the vicinity of an elevator. Additionally, smart floor system 110 includes, but is not limited to, a speaker and a microphone (not shown) to play audio prompts and receive spoken instructions from a user, respectively. When detection program 112 identifies a characteristic movement of a movement assisting device, then detection program 112 sends a command to voice recognition program 114 to prompt the user for an instruction or other indication of operation for the elevator (e.g., a destination floor). Voice recognition program 114 interprets the received voice command, and sends the command to the operable device associated with smart floor system 110. Smart floor system 110 is communicatively coupled to the operable device (i.e., elevator) in order to send electronic commands representing the users voiced instruction. Voice recognition program 114 sends the electronic commands based on the received and determined spoken instruction made by the user. At that time the operable device responds and performs the requested action. One of ordinary skill in the art can appreciate than any type of operable device may be used without deviating from the invention. Furthermore, for devices with simple or singular operations, such as an automatic door, voice recognition program 114 may not be implemented.

In various embodiments, characteristic movement represents a movement of a specific device that may be distinguished from other devices or persons. Thus, in some embodiments and scenarios, detection program 112 is configured to analyze a dynamic sample of signals generated by the matrix of pressure sensors that allow detection program 112 to determine a correlation with a specific kind of movement assisting device. In some embodiments and scenarios, there detection program 112 is configured to use, and includes, a set of rules for detecting individuals using movement assisting devices. In some embodiments, voice recognition program 114 and corresponding audio producing and receiving components are separate from smart floor system 110. In some scenarios and embodiments, such a separation facilitates recognition of spoken instructions and translation of the spoken instructions into control signals, by voice recognition program 114, for, e.g., elevators, doors or other technical equipment.

In various embodiments, one or more limitations of static recognition systems for detection of movement assisting devices are overcome, by one or both of voice recognition program 114 and detection program 112, because they are not based on a snapshot of an activation of pressure sensors. In one embodiment described herein, a method is described that is configured to utilize a dynamic recognition of a movement of the movement assisting device, e.g., a wheelchair. In one such embodiment, one or more of the pressure, timing, and spacing of readings are evaluated for a more accurate recognition of and identification of the movement assisting device. In some embodiments and scenarios, this includes identifying the type of movement assisting device being used by the individual. In some embodiments and scenarios, detection program 112 is configured to predict whether a user of the device will be able to perform a required movement. For example, detection program 112 predicts whether a person will be able to press an elevator panel button based on their location and the size and location of a movement assisting device. In some embodiments, locations and devices have a profile that indicates to detection program 112 probable movements and location a user will likely have to reach to make those movement. Using this information, in combination with sensors data, and profile data for the movement assisting device, detection program 112 is able to determine what the user will likely need to do. If detection program 112 determines that the user will likely be unable to accomplish the predicted action, task, etc., then detection program 112 activates one or more systems to assist the individual in completion of the task. For example, detection program 112 activates a voice recognition and command system that allows the individual to use voice commands to operate one or more devices. In one embodiment and scenario, such a method is applied to strollers and people using crutches to determine whether they will be able to reach a predicted location (e.g., a goal, such as a telephone in a telephone booth). In some embodiments and scenarios, the characteristics used for determining the characteristic movement of people with a movement assisting device is adapted to differentiate specific categories of movement assisting devices. For example, one such category includes movement assisting devices used by an individual to facilitate their own movement. Another category includes movement assisting devices that are used to move cargo, i.e., a load. In some scenarios, an individual moving cargo retains far more mobility when compared to an individual using the movement assisting device to facilitate their own movement. As such, in some embodiments, for example, walking frames are categorized and detected by detection program 112 in a similar manner as wheelchairs. Thus, in one embodiment, the proposed method and system is configured for use in an elevator, in front of a building, a door (e.g., a public building like a hospital) or any other places where people using movement assisting devices require assistance.

According to one embodiment, sensor matrix 116 comprises hexagonal pressure sensors adjacent to each other, respectively. However, in some embodiments, other, sometimes regularly shaped and placed, pressure sensors are used (e.g., squared, rectangular, or octagonal). In some scenarios and embodiments regular hexagons have an advantage that a plane or mat may be completely covered with hexagons of the same size without any empty spaces in between the sensors that would yield an area that is not monitored in the sensor grid large enough to disrupt the functioning of detection program 112 via loss of sensor data. Additionally, in some scenarios and embodiments, use of adjacent hexagonal pressure sensors increases direction sensitivity when compared to, for example square or rectangular pressure sensors. In some scenarios and embodiments, use of sensors with more sides (e.g., above six), can yield area that is not monitored in the sensor grid large enough to disrupt the functioning of detection program 112 via loss of sensor data. Such un-monitored areas can be generated by repetition of certain geometrically shaped sensors on a given surface being monitored. In one embodiment, sensors of various shapes and sizes are combined to increase sensitivity and coverage of a surface such that any areas that are not monitored in the sensor grid are minimized.

According to one embodiment and example, the movement assisting device is a device included in the group comprising: a wheelchair, a stroller, a related stretcher and a walking frame. In this example, at least some of these devices have four wheels. However, there is a further subset that includes version of such devices that have one, two, three, or five or more wheels. In such an embodiment, detection program 112 is configured to determine the characteristic movement for none-standard movement assisting devices in a given category.

According to an embodiment, determination of the characteristic movement of the movement assisting device includes determining whether two first pressure sensors are activated in a pathway, e.g., in particular a straight line, with a predefined distance. For example, the predefined distance may be between 35 and 60 cm, while other distances are possible.

According to an embodiment, a determination of the characteristic movement of the movement assisting device includes determining whether other pressure sensor were activated between two given pressure sensors that were activated. According to an embodiment, the characteristic movement of the movement assisting device is determined based on which presser sensors included in a group of sensors are activated. In one such scenario and embodiment, it is determined that a given pressure sensor will not be activated if the movement assisting device meets the criteria included in a profile for a type of movement assisting device, Such a profile includes data indicating that there should be no pressure applied to sensors that are between four regions of activated pressure sensors, which correspond to the theoretical locations of the wheels of the movement assisting device. Thus, activation of the sensors between the wheels indicates that the wheels of the movement assisting device do not match the profile for that type of movement assisting device and therefore another profile should be used to identify the type of movement assisting device. However, in some embodiments, such a profile accounts for possible movement of one or more individuals. For example, the space between the activated pressure sensors may be transiently occupied by an individual pushing or pulling the movement assisting device. For example, a person pushing a cart would activate sensors that are directly behind the device but are still between the sensors that were activated by the wheels of the cart. However, the sensors between the wheels of the cart themselves are not activated while the cart is over them. As such, according to an embodiment, detection program 112 is configured to determine the type of movement assisting device, the location of a user of the movement assisting device, and a direction of travel, both predicted and measured, based on such sensor data and profile information for various movement assisting devices.

According to an embodiment, the determining the characteristic movement of the movement assisting device includes determining whether two proximal pressure sensors, of which each one is individually and directly adjacent to one of the first two pressure sensors, are activated in a line with the predefined distance, and determining whether the first two pressure sensors are released at the same time. In some scenarios and embodiments, such an occurrence demonstrates a dynamic nature of the disclosed method. For example, the movement assisting device is moved forward. As such, the detection of the characteristic movement is used as a basis for a differentiation to known technologies.

According to an embodiment, determining the characteristic movement of the movement assisting device includes determining whether the activation of the two next pressure sensors, which follow after two previously activated sensors, last for a predefined amount of time. For example, the predefined amount of time is two seconds. In some scenarios and embodiments such a time span is sufficient for detection program 112 to identify and correct for errors and contracting data. For example, errors in measurements, or the differentiation between two data sets that correspond to different individuals and/or movement assisting devices, e.g., two pressure sensors activated by accident by walking people.

According to one embodiment, the matrix of pressure sensors is a part of an elevator floor and the speech recognition system is adapted to accept commands for operating the elevator. Additionally, the speech recognition system is configured to activate other technical equipment, which is otherwise operated by using, for example, manual devices such as, for example, knobs and switches. Some examples of such devices include an automatic door, a TV, a radio receiver, and other electronic home devices. According to one embodiment, the matrix of pressure sensors are included in cars in which, for example, the driver seat has an empty space into which a mobility assisting device can be fixed, i.e., held in place or otherwise stored. In one such embodiment and scenario, such a car is partially autonomous in that is operated by an individual using the speech recognition system and the automatic detection of the mobility assisting device (i.e., the car is operated with limited manual input from the user).

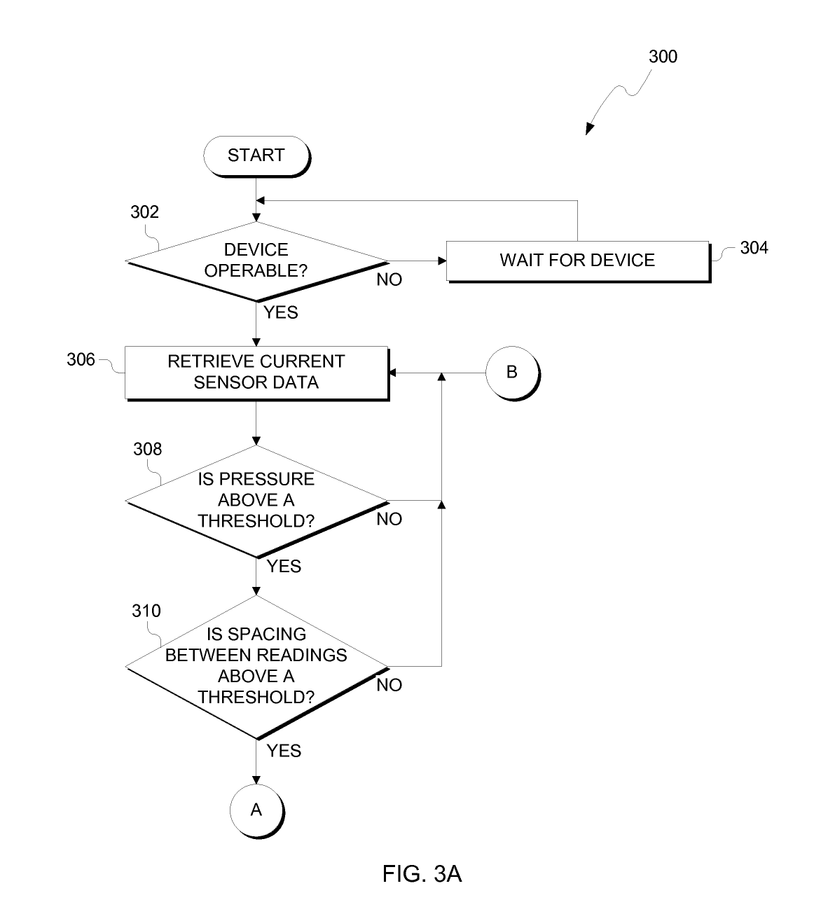

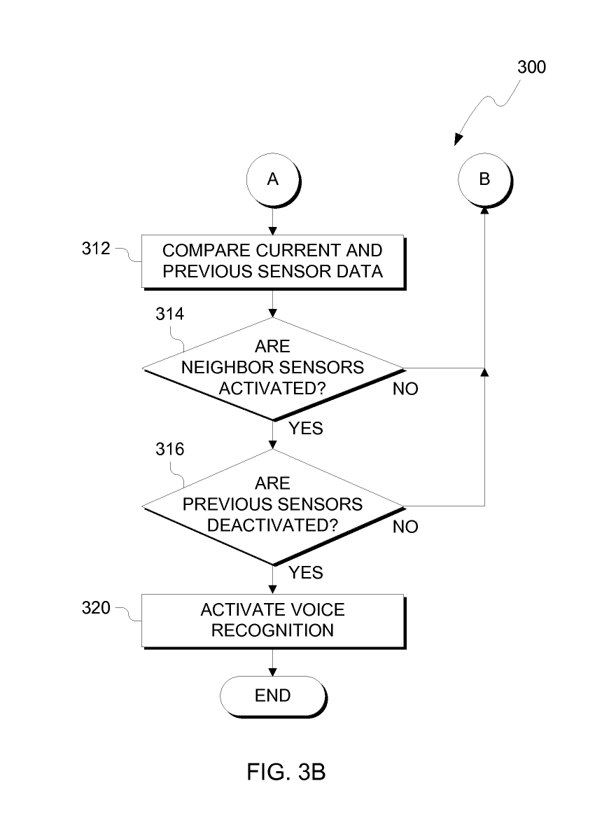

FIGS. 3A & 3B illustrate operational processes, generally designated 300, of detection program 112 of smart floor system 110. In decision process 302, detection program 112 determines if the associated device is operable. In some scenarios, the operable device is not in a state to receive new instructions (e.g., an elevator is out of order). As such, detection program 112 receives an indication for the communicatively coupled device if the device is currently operable or able to receive instructions. If the device is not operable (NO branch of decision process 302), the detection program 112 waits for the device to become operable. Once the device is operable (YES branch of decision process 302), then detection program 112 retrieves current sensor data from sensor matrix 116 (process 304). In some embodiments, decision process 302 may be done parallel to or independently of other operational processes 300. For example, detection program 112 retrieves and analyzes sensor data from sensor matrix 116. If, at any time, the device becomes inoperable or otherwise unable to receive commands, detection program 112 may wait for the device to become operable before receiving voice commands or sending instructions to the device.

In decision process 306, detection program 112 receives current sensor data from sensor matrix 116. Current sensors data includes the pressure readings of the sensors and the locations the pressure readings were registered. In decision process 308, if the pressure readings for the activated sensors are below a certain threshold (NO branch of decision process 308), then detection program 112 retrieves sensor data until pressure readings are above the threshold (YES branch of decision process 308). As such, movement assisting devices with smaller surface areas can be detected since such movement assisting device movement assisting device would be distributing a similar mass over a smaller area, characteristic of a movement assisting device within the area of sensor matrix 116.

In decision process 310, detection program 112 determines if a spacing between activated sensors is within a threshold. Since movement assisting device movement assisting device are made to be specific sizes, the known spacing between points of contacts with sensor matrix 116 is known (e.g., the width of a wheel chair). Furthermore, most movement assisting device movement assisting device are wider than the occupant or user. As such, spacing for reading above typical standing or walking widths are characteristic of a movement assisting device. For example, wheelchairs are typically 26 inches wide, while a normal human stance is less than eighteen inches wide. Based on the arrangement and size of sensors in sensor matrix 116, detection program 112 determines a distance between contact points for use in decision process 310. If the distance is above the normal spacing width for a human, then detection program 112 (YES branch for decision process 310), then detection program 112 compares the current sensor data to the previous sensor data (process 312). If the spacing is within range of a normal human stance or gait (NO branch of decision process 310), then detection program 112 retrieves the current sensor data for updated changes (process 306).

In process 312, detection program 112 compares previous sensor data to the current readings from sensor matrix 116. In decision processes 314 and 316, detection program 112 determine if the of timing of sensor data indicates a line of movement where a line of sensors have been activated. In decision process 314, detection program 112 determines if neighboring sensors to previously activated sensors in sensor matrix have been activated. If no new sensors have been activated (NO branch of decision process 314), then detection program 112 retrieves updated sensor data (process 306). In some scenarios, this may indicate that no movement has occurred between readings. In other scenarios, such as a person walking without a movement assisting device, this may indicate a stepping motion (e.g., picking up and placing a foot in a step motion) as opposed to the continuous wheeled movement of some movement assisting device movement assisting device (e.g., a wheelchair). If neighboring sensors from previous reading of sensors matrix 116 have been activated (YES branch of decision process 314), the detection program 112 determines if corresponding neighboring sensors have been deactivated (decision process 316).

In decision process 316, detection program 112 determines if previous neighboring sensors have been deactivated. In some scenarios, walking devices have known “footprints” or areas of contact when on a floor. Detection program 112 determines if based on the known footprints, corresponding sensors have been deactivated. For example, if a wheel on a wheelchair comes in contacts with a floor for four inches, detection program 112 determines if the grouping of sensors activated match the footprint distance. If previously activated sensors do not deactivate (NO branch of decision process 316), then the footprint area of activated on sensor matrix 116 may not be from a movement assisting device. If the corresponding sensors are deactivated (YES branch of decision process 316), then detection program 112 confirms the movement is characteristic of a movement assisting device and sends an instruction to voice recognition program to activate and request a voice command from the user (process 320).

FIG. 4 depicts a block diagram, 400, of components of smart floor system 110, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Smart floor system 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Detection program 112 and voice recognition program 114 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 120. In these examples, communications unit 410 includes one or more network interface cards. Communications unit 410 may provide communications through the use of either or both physical and wireless communications links. Detection program 112 and voice recognition program 114 may be downloaded to persistent storage 408 through communications unit 410.

I/O interface(s) 412 allows for input and output of data with other devices that may be connected to smart floor system 110. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., detection program 112 and voice recognition program 114, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1. A method comprising:
retrieving, by one or more processors, a plurality of pressure readings from a matrix of pressure sensors;
identifying, by the one or more processors, a movement within the matrix of pressure sensors based, at least in part, on the plurality of pressure readings; and
in response to a determination that the movement is characteristic of a movement assisting device, enabling, by the one or more processors, a voice recognition system for receiving speech commands to operate a device.

2. The method of claim 1, wherein the matrix of pressure sensors comprises a plurality of adjacent hexagonal pressure sensors.

3. The method of claim 1, wherein the movement assisting device is (i) a wheelchair, (ii) a stroller, (iii) a stretcher, (iv) a walking frame, or (v) a load bearing device.

4. The method of claim 1, wherein the determination of the movement is characteristic of the movement assisting device is based, at least in part, on a first set of one or more neighboring pressure sensors being activated.

5. The method of claim 4, wherein a second set of one or more neighboring pressure sensors are deactivated.

6. The method of claim 1, wherein the determination of the movement is characteristic of the movement assisting device is based, at least in part, on a distance between a first group of activated pressure sensors and a second group of activated pressure sensors.

7. The method of claim 6, wherein the distance is equal to the width of the movement assisting device.

8. A computer program product comprising:
one or more computer-readable storage media and program instructions stored on the one or more computer-readable storage media, the program instructions comprising:
program instructions to retrieve a plurality of pressure readings from a matrix of pressure sensors;
program instructions to identify a movement within the matrix of pressure sensors based, at least in part, on the plurality of pressure readings; and
in response to a determination that the movement is characteristic of a movement assisting device, program instructions to enable a voice recognition system for receiving speech commands to operate a device.

9. The computer program product of claim 8, wherein the matrix of pressure sensors comprises a plurality of adjacent hexagonal pressure sensors.

10. The computer program product of claim 8, wherein the movement assisting device is (i) a wheelchair, (ii) a stroller, (iii) a stretcher, (iv) a walking frame, or (v) a load bearing device.

11. The computer program product of claim 8, wherein the determination of the movement is characteristic of the movement assisting device is based, at least in part, on a first set of one or more neighboring pressure sensors being activated.

12. The computer program product of claim 11, wherein a second set of one or more neighboring pressure sensors are deactivated.

13. The computer program product of claim 8, wherein the determination of the movement is characteristic of the movement assisting device is based, at least in part, on a distance between a first group of activated pressure sensors and a second group of activated pressure sensors.

14. The computer program product of claim 13, wherein the distance is equal to the width of the movement assisting device.

15. A computer system comprising:
one or more computer processors;
one or more computer readable storage media; and
program instructions stored on the computer readable storage media for execution by at least one of the one or more processors, the program instructions comprising:
program instructions to retrieve a plurality of pressure readings from a matrix of pressure sensors;
program instructions to identify a movement within the matrix of pressure sensors based, at least in part, on the plurality of pressure readings; and
in response to a determination that the movement is characteristic of a movement assisting device, program instructions to enable a voice recognition system for receiving speech commands to operate a device.

16. The computer system of claim 15, wherein the matrix of pressure sensors comprises a plurality of adjacent hexagonal pressure sensors.

17. The computer system of claim 15, wherein the movement assisting device is (i) a wheelchair, (ii) a stroller, (iii) a stretcher, (iv) a walking frame, or (v) a load bearing device.

18. The computer system of claim 15, wherein the determination of the movement is characteristic of the movement assisting device is based, at least in part, on a first set of one or more neighboring pressure sensors being activated.

19. The computer system of claim 18, wherein a second set of one or more neighboring pressure sensors are deactivated.

20. The computer system of claim 15, wherein the determination of the movement is characteristic of the movement assisting device is based, at least in part, on a distance between a first group of activated pressure sensors and a second group of activated pressure sensors.
